(19) United States
(12) Patent Application Publication
(10) Pub. No.: US 2010/0161363 A1
(43) Pub. Date: Jun. 24, 2010

(54) ENVIRONMENTAL LOAD ANNOUNCING APPARATUS, MULTIFUNCTION PERIPHERAL, AND ENVIRONMENTAL LOAD ANNOUNCING METHOD

(75) Inventors: Rintarou Nakane, Kanagawa-ken (JP); Yoshikatsu Kamisuwa, Tokyo-to (JP); Hiroyo Katou, Shizuoka-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/640,270

(22) Filed: Dec. 17, 2009

Related U.S. Application Data
(60) Provisional application No. 61/140,019, filed on Dec. 22, 2008.

(51) Int. Cl. G06Q 10/00; G06Q 50/00; H04N 1/60

(52) U.S. Cl. 705/7; 705/317; 358/1.9

(57) ABSTRACT

An environmental-load announcing apparatus calculates, as an execution value, a value of an environmental load required by a printer to print a print target image on a sheet, sets, as a reference value, a value of an environmental load caused if the printer prints, with reference setting content, the print target image on the sheet and calculates a degree of the calculated execution value with respect to the reference value, and causes a display device to display, as a degree of effort with respect to the environmental load in the printing executed by the printer, the degree of the execution value with respect to the calculated reference value.

### CROSS-REFERENCE TO RELATED APPLICATION

This application claims the benefit of U.S. Provisional Application No. 61/140,019, filed Dec. 22, 2008.

### TECHNICAL FIELD

The present invention relates to a technique for facilitating a reduction in load on the environment due to image forming apparatuses such as a digital multifunction peripheral, a copying machine, and a network printer.

### BACKGROUND

In recent years, in various industrial fields, attempts for reducing an environmental load such as a reduction in emission of carbon dioxide are carried out. Concerning image forming apparatuses such as a digital multifunction peripheral, ideas for reducing an environmental load are proposed. For example, EP-A-1280083 discloses a method of transmitting information concerning an environmental load from an image forming apparatus to a management apparatus and managing the information concerning the environmental load in the management apparatus.

However, EP-A-1280083 does not disclose a technique for reporting the information concerning the environmental load to users. In particular, there is no disclosure about reporting of information concerning an environmental load other than paper and the like used by the users. Therefore, the users cannot recognize a state of an actual environmental load, a degree of improvement of the environmental load, or the like. As a result, the users lack the motivation to reduce the environmental load.

### SUMMARY

According to an aspect of the present invention, there is provided an environmental load announcing apparatus configured to announce an environmental load in a printer, the environmental load announcing apparatus including: an execution-value calculating unit configured to calculate, as an execution value, a value of an environmental load required by the printer to print a print target image on a sheet; a degree calculating unit configured to set, as a reference value, a value of an environmental load caused if the printer prints, with reference setting content, the print target image on the sheet and calculate a degree of the execution value calculated by the execution-value calculating unit with respect to the reference value; and a control unit configured to cause a display device to display information based on the degree of the execution value with respect to the reference value calculated by the degree calculating unit.

According to another aspect of the present invention, there is provided a multifunction peripheral including: a scanner configured to read an image of an original document; a printer configured to print the image on a sheet; an execution-value calculating unit configured to calculate, as an execution value, a value of an environmental load required by the printer to print the image of the original document read by the scanner on the sheet; a degree calculating unit configured to set, as a reference value, a value of an environmental load caused if the printer prints, with reference setting content, the image of the original document read by the scanner on the sheet and calculate a degree of the execution value calculated by the execution-value calculating unit with respect to the reference value; and a display device configured to display information based on the degree of the execution value with respect to the reference value calculated by the degree calculating unit.

According to still another aspect of the present invention, there is provided an environmental-load announcing method including: calculating, as an execution value, a value of an environmental load required by a printer to print a print target image on a sheet; setting, as a reference value, a value of an environmental load caused if the printer prints, with reference setting content, the print target image on the sheet and calculating a degree of the calculated execution value with respect to the reference value; and causing a display device to display, as a degree of effort with respect to the environmental load in the printing executed by the printer, the degree of the execution value with respect to the calculated reference value.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic diagram of a configuration example of an image forming system;

FIG. 2 is a schematic sectional view of an internal mechanism of a digital multifunction peripheral;

FIG. 3 is a block diagram of a configuration example of a control system for the digital multifunction peripheral;

FIG. 4 is a block diagram of a configuration example of a management server and a user terminal;

FIG. 5 is a diagram of a configuration example of a lookup table for a maximum value;

FIG. 6 is a table of an example of history data;

FIG. 7 is a flowchart for explaining processing for announcing a degree of effort for an environmental load; and

FIG. 8 is a diagram of an example in which information concerning an environmental load related to a specific user.

### DETAILED DESCRIPTION

An embodiment of the present invention is explained below with reference to the accompanying drawings.

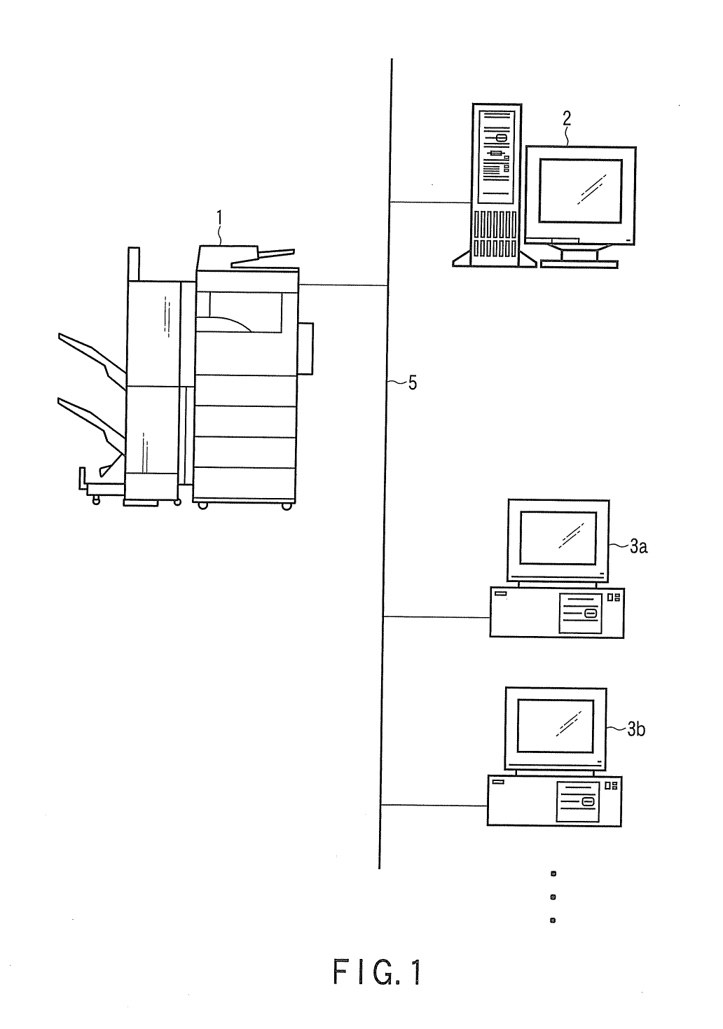

FIG. 1 is a diagram of a schematic configuration of an image forming system including a digital multifunction peripheral as an image forming apparatus. The image forming apparatus also functions as an environmental load announcing apparatus.

As shown in FIG. 1, the image forming system includes a digital multifunction peripheral 1, a management server 2, and user terminals 3. The digital multifunction peripheral 1, the management server 2, and the user terminals 3 (3a, 3b, . . . ) are connected to one another by a local area network 5.

The digital multifunction peripheral (MFP) 1 has a scanner function, a printer function, a network communication function, and a copy function. The digital multifunction peripheral 1 functions as an image forming apparatus. The management server 2 includes a server computer. The management server 2 has a function of performing transmission and reception of data between the digital multifunction peripheral 1 and the user terminals 3 via the local area network 5. The user terminals 3 (3a, 3b, . . . ) include personal computers. The user terminals 3 are terminal apparatuses used by users. The user terminals 3 are connected to digital multifunction peripherals 1 and management servers 2 in local area networks 5.

The digital multifunction peripheral 1 has a function of measuring operation times and the like of the units as information indicating an environmental load in image formation processing such as driving times and the like of the units. The digital multifunction peripheral 1 has a function of calculating an environmental load value indicating an environmental load, transferring the environmental load value to the management server 2, and displaying the environmental load value on a display device. The management server 2 collects the environmental load value from the digital multifunction peripheral 1 in the local area network 5 and manages the environmental load value. The user terminals 3 request the digital multifunction peripheral 1 to execute printing. The user terminals 3 display an environmental load value due to the printing executed by the digital multifunction peripheral 1.

However, the management server 2 or the user terminals 3 may calculate an environmental load value in image formation executed by the digital multifunction peripheral 1. In this case, the digital multifunction peripheral 1 transfers information indicating an environmental load measured during processing such as copying or printing (e.g., operation times of the units or a consumption amount of consumables) to the management server 2 or the user terminals 3. The management server 2 or the user terminals 3 only have to calculate an environmental load value from the information indicating the environmental load such as the operation times of the units supplied from the digital multifunction peripheral 1.

The internal configuration of the digital multifunction peripheral 1 is explained below.

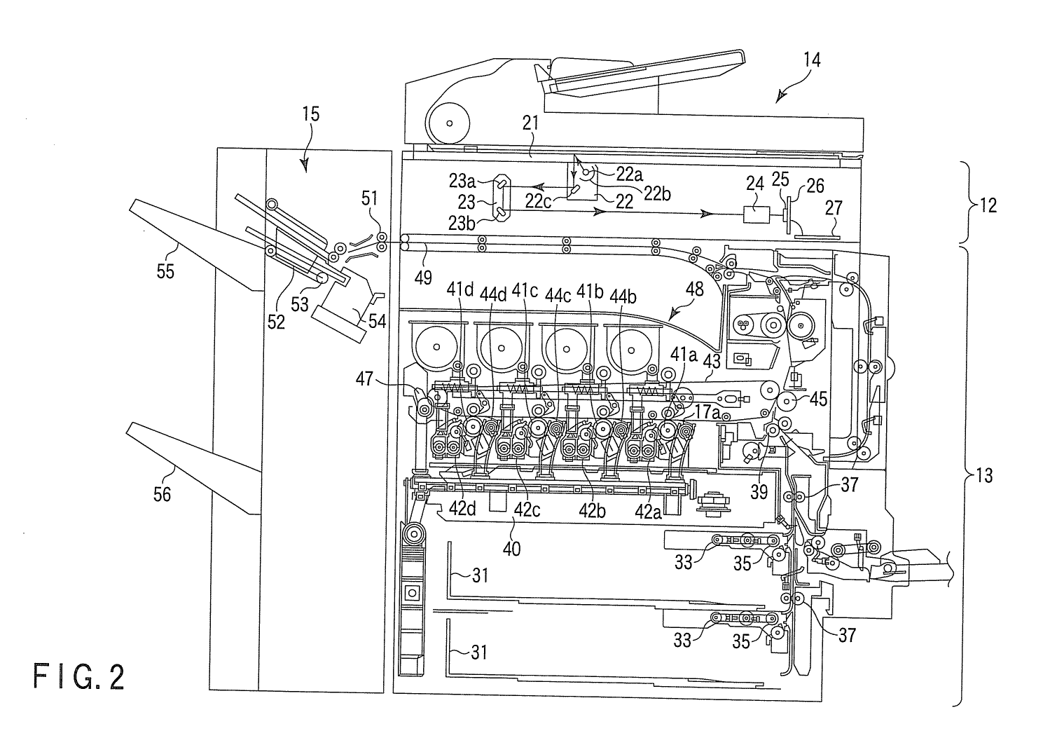

FIG. 2 is a sectional view of an internal configuration example of a color digital multifunction peripheral.

In the configuration example shown in FIG. 2, the digital multifunction peripheral 1 includes a scanner (an image reading unit) 12, a printer (an image forming unit) 13, an automatic document feeder (ADF) 14, a finisher 15, and an operation unit (a control panel (not shown in FIG. 2)) 16. The digital multifunction peripheral 1 also includes various external interfaces for inputting and outputting image data. For example, the digital multifunction peripheral 1 includes a facsimile interface for transmitting and receiving facsimile data and a network interface for performing network communication. With such a configuration, the digital multifunction peripheral 1 functions as a copying machine, a scanner, a printer, a facsimile, and a network communication machine.

The configuration of the scanner 12 is explained below.

The scanner 12 is a unit configured to optically scan the surface of an original document to thereby read an image on the original document as color image data (multi-value image data) or monochrome image data. The scanner 12 includes, as shown in FIG. 2, the ADF 14, a document table glass 21, a first carriage 22, a second carriage 23, a condensing lens 24, a photoelectric conversion unit 25, a CCD substrate 26, and a CCD control board 27. The first carriage 22 is mounted with a light source 22a, a reflector 22b, and a first mirror 22c. The second carriage 23 includes a second mirror 23a and a third mirror 23b.

The configuration of the printer 13 is explained below.

The printer 13 is a unit configured to form an image based on color image data (multi-value image data) or monochrome image data on a sheet. The printer 13 includes, as shown in FIG. 2, a sheet feeding unit 30, an exposing device 40, first to fourth photoconductive drums 41a to 41d, first to fourth developing devices 42a to 42d, a transfer belt 43, cleaners 44a to 44d, a transfer device 45, a fixing device 46, a belt cleaner 47, a first paper discharge unit 48, and a second paper discharge unit 49.

The sheet feeding unit 30 feeds a sheet, onto which a toner image is transferred from the transfer belt 43 as an intermediate transfer member, to the transfer device 45. The sheet feeding unit 30 has a configuration for feeding, at appropriate timing, the sheet to a transfer position where the toner image is transferred by the transfer device 45. In a configuration example shown in FIG. 2, the sheet feeding unit 30 includes plural cassettes 31, pickup rollers 33, separating mechanisms 35, conveying rollers 37, and aligning rollers 39.

The finisher 15 is provided to be connected to the second paper discharge unit 49. The finisher 15 includes paper feeding rollers 51, a stacker 52, a conveying roller 53, a stapler 54, and paper discharge trays 55a and 55b.

The configuration of a control system for the digital multifunction peripheral 1 is explained below.

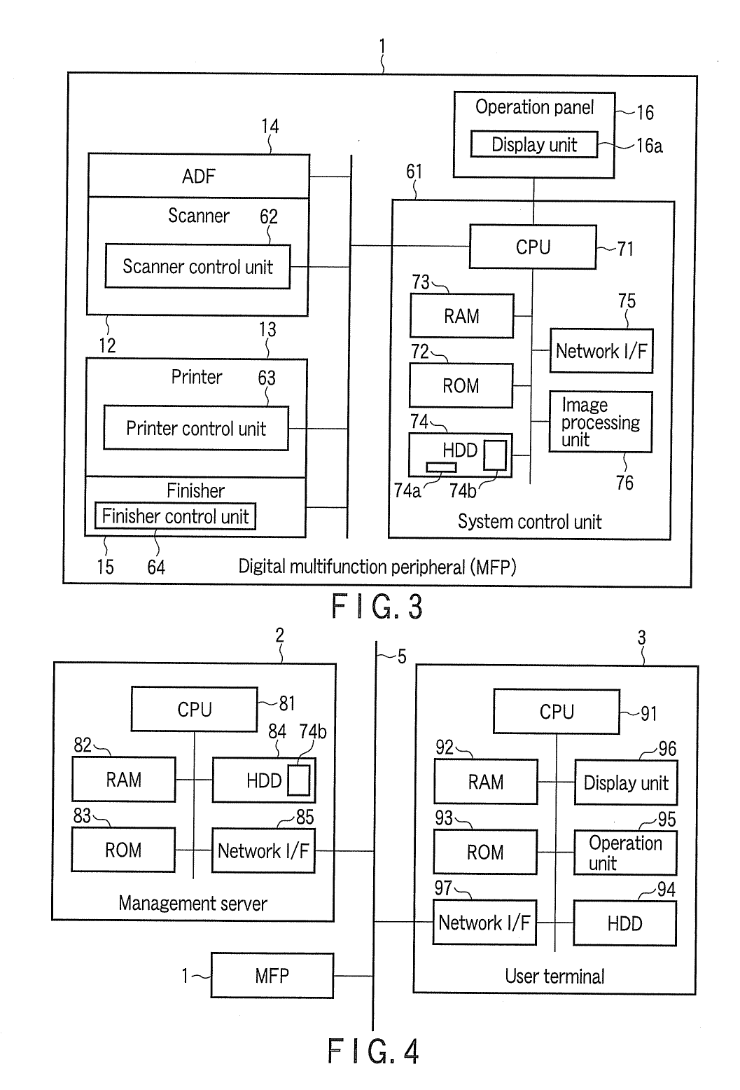

FIG. 3 is a block diagram of a configuration example of the control system for the digital multifunction peripheral 1.

As shown in FIG. 3, the control system for the digital multifunction peripheral 1 includes the operation panel 16, a system control unit 61, a scanner control unit 62, a printer control unit 63, and a finisher control unit 64.

The system control unit 61 performs the control of the entire digital multifunction peripheral 1. The system control unit 61 includes a CPU 71, a ROM 72, a RAM 73, a HDD 74, a network interface 75, and an image processing unit 76.

In the system control unit 61, the CPU 71 executes a control program stored in the ROM 72 or the HDD 74 to thereby realize various processing functions. The ROM 72 has stored therein a control program, control data, and the like for managing the operation of the digital multifunction peripheral 1. The RAM 73 is a memory configured to temporarily store data. The HDD 74 is a large-capacity memory for data storage. The network interface 75 is a LAN interface for performing communication with an external apparatus via the local area network 5. The image processing unit 76 applies image processing to image data read by the scanner 12, image data for printing received through a network, or the like.

The operation panel 16 is connected to the system control unit 61. The operation panel 16 is, for example, a user interface including various operation keys and a display device incorporating a touch panel. In other words, the operation panel 16 functions as an operation unit for a user to input an operation instruction and also functions as a display unit 16a configured to display guidance and the like for the user.

The scanner control unit 62 controls the units of the scanner 12 according to an operation instruction from the system control unit 61. For example, the scanner control unit 62 drives to move the first and second carriages 22 and 23 to thereby convert an image of an original document on the document table glass 21 into image data. In this case, the scanner control unit 62 performs driving control corresponding to a size of the original document. The scanner control unit 62 has a function of measuring operation times of the units in the scanner 12. The scanner control unit 62 supplies information indicating the operation times of the units to the system control unit 61.

For example, the scanner control unit 62 moves the first and second carriages 22 and 23 according to the size in a sub scanning direction of an original document. The scanner control unit 62 turns on the light source 22a according to the movement in the sub-scanning direction of the first carriage 22. Specifically, as the size is larger in the sub-scanning direction, a movement amount of the first and second carriages 22 and 23 is larger and the lighting time of the light source 22a is longer. This means that, as the size is larger in the sub-scanning direction, electric power consumed for driving the scanner 12 is larger.

The scanner control unit 62 can also drive the ADF 14 to thereby read an image of an original document set on the ADF 14. The scanner control unit 62 performs driving control for conveying the original document according to the size in the sub-scanning direction of the original document (a conveying direction of the original document). Specifically, when the original document is read by using the ADF 14, as in the case in which the ADF 14 is not used, as the size in the sub-scanning direction is larger, a movement amount of the first and second carriages 22 and 23 is larger and the lighting time of the light source 22a is longer. This means that electric power consumed for driving of the entire scanner 12 is larger.

The printer control unit 63 controls the units of the printer 13 according to an operation instruction from the system control unit 61. The printer control unit 63 has a function of measuring a state or an operation result in the printer 13. For example, the printer control unit 63 has a function of measuring operation times (or the numbers of times of operation) of the units of the printer 13, a function of measuring a consumption amount of consumables with not-shown various sensors, and a function of measuring the temperature in the printer 13 with a not-shown temperature sensor. The printer control unit 63 supplies information indicating the operation times of the units, the consumption amount of the consumables, the temperature, or the like to the system control unit 61. These kinds of information are also used as information indicating an environmental load.

In print processing, the printer control unit 63 drives rollers of a conveying system to thereby convey a sheet, on which an image is printed, in the printer 13. The printer control unit 63 controls the exposing device 40, the photoconductive drums 41, a developing device 42, the transfer belt 43, the transfer device 45, and the like to thereby form an image on the transfer belt 43. The printer control unit 63 conveys the sheet to the image transfer position to be timed to coincide with the image formed on the transfer belt 43 to thereby transfer the image onto the sheet. The printer control unit 63 drives the fixing device 46 to thereby fix the image transferred on the sheet.

In the print processing explained above, as the size in the conveying direction of the sheet is larger, driving time of the rollers of the conveying system, driving time of the fixing device, and the like are longer. This means that, as the size in the conveying direction of the sheet is larger, electric power consumed by the entire printer 13 is larger.

In color printing, an image is formed by plural colors (three colors). On the other hand, in monochrome printing, one image (a black image) only has to be formed. In other words, in the color printing, since an image is formed by the plural colors (three colors), power consumption is large and a consumption amount of toners and the like are also large compared with the monochrome printing. This means that an environmental load is large in the color printing compared with the monochrome printing.

The finisher control unit 64 controls the units of the finisher 15 according to an operation instruction from the system control unit 61 or the printer control unit 63. The finisher control unit 64 has a function of measuring operation times of the units of the finisher 15. The finisher control unit 64 supplies information indicating the operation times of the units to the system control unit 61.

In stapling, the finisher control unit 64 accumulates sheets on which images are formed by the printer 13 and staples the sheets with the stapler 54. Therefore, for the stapling, electric power for driving a stapling mechanism of the stapler 54 is necessary and staples are consumed. In other words, when the stapling is executed, an environmental load increases.

The configuration of the management server 2 and the user terminal 3 is explained below.

FIG. 4 is a schematic block diagram of a configuration example of the management server 2 and the user terminal 3.

As shown in FIG. 4, the management server 2 includes a CPU 81, a RAM 82, a ROM 83, a HDD 84, and a network interface (I/F) 85.

The CPU 81 manages the control of the entire management server 2. The RAM 82 temporarily stores work data and the like. The ROM 83 has stored therein a control program and the like for managing the basic operation of the management server 2. The HDD 84 is a storage device for data storage and stores history data and the like collected from digital multifunction peripherals 1. The network interface 85 is a LAN interface for performing data communication with apparatuses in the local area network 5. For example, the management server 2 can perform data transmission and reception with the digital multifunction peripheral 1 and the user terminals 3 in the local area network 5 through the network interface 85. The CPU 81 realizes various processing functions on the basis of the control programs stored in the ROM 83 and the HDD 84.

The user terminal 3 has a configuration same as that of a general personal computer. For example, in the configuration example shown in FIG. 4, the user terminal 3 includes a CPU 91, a RAM 92, a ROM 93, a HDD 94, an operation unit 95, a display unit 96, and a network interface 97.

The CPU 91 manages the control of the overall user terminal 3. The RAM 92 temporarily stores work data and the like. The ROM 93 has stored therein a control program and control data for managing the basic operation of the user terminal 3. The HDD 94 is a storage device for data storage. The operation unit 95 is a keyboard, a pointing device, and the like for the user to input an operation instruction. The display unit 96 includes a liquid crystal display. The network interface 97 is a LAN interface for performing data communication with the apparatuses in the local area network 5. For example, the user terminal 3 can perform data transmission and reception with the management server 2 and the digital multifunction peripheral 1 in the local area network 5 through the network interface 97. The CPU 91 realizes various processing functions on the basis of the control programs stored in the ROM 93 and the HDD 94.

An environmental load in the digital multifunction peripheral 1 is explained below.

In the digital multifunction peripheral 1 configured as explained above, for example, factors of an environmental load concerning image formation processing include consumables, deteriorated components, electric power, and undeteriorated components.

The consumables include sheets, toners, and staples. When a consumption amount of the consumables is large, an environmental load is considered to be large. The deteriorated components include photoconductive drums, a belt, rollers of a conveying system, a fixing roller, a cleaner, and developers. When deterioration in the deteriorated components is severe (the deteriorated components are deteriorated in a short period), an environmental load is large. The electric power includes electric power consumed for fixing, electric power consumed for logic operation, electric power consumed for driving of a driving mechanical system, and electric power consumed for driving of a laser. When the consumption of the electric power is large, an environmental load is also large. The undeteriorated components include components having durable life as long as durable life of a main body structure and the like. However, the undeteriorated components do not have to be a factor of an environmental load because the durable life thereof is the same as the durable life of the digital multifunction peripheral 1 itself.

In some case, in the digital multifunction peripheral 1, load on the environment decreases or increases depending on content (a pattern of use) of an operation instruction of the user.

For example, in the digital multifunction peripheral 1, usually, as the number of products obtained by print processing (i.e., the number of printed sheets) is larger, an environmental load increases because of consumption of the consumables, replacement of the deteriorated components, power consumption, the durable life of the undeteriorated components, and the like. To reduce such an environmental load, the products obtained by the print processing (the number of printed sheets) can be reduced.

For example, an environmental load is smaller when duplex printing is performed than when simplex printing is performed on two sheets. An environmental load is smaller when an image of the A3 size is reduced to an image of the A4 size and printed on a sheet of the A4 size than when the image of the A3 size is printed on a sheet of the A3 size. An environmental load is smaller when N images are reduced according to a sheet size and printed side by side on one sheet (hereinafter referred to as N-in-1 printing) than when the N images are printed on sheets matching the sizes of the images.

Even if the number of products obtained as a result of printing (prints) is the same, an environmental load may increase or decrease depending on the setting of an original document, the setting of a sheet, or the setting of an operation mode. For example, as the size in the conveying direction of a sheet is smaller, an environmental load is smaller because time for driving the rollers of the conveying system is shorter. As a specific example, an environmental load is smaller in processing in A4 (a short side direction is the conveying direction) than in processing in A4R (a long side direction is the conveying direction).

Factors of an environmental load that increases or decreases depending on the pattern of use include a sheet size, a paper feeding direction, a paper feeding cassette, color or monochrome, simplex or duplex, N-in-1, and sorting and stapling.

The reduction in a consumption amount of the consumables, a quantity of use of the deteriorated components, and the power consumption has an effect not only in reducing an environmental load but also in reducing cost required for operation and maintenance. For example, the reduction in a consumption amount of the consumables and the power consumption can directly reduce cost in operation. The reduction in a quantity of use of the deteriorated components (operation time and the number of times of operation) means that deterioration in the deteriorated components required to be replaced is suppressed (a cycle of component replacement is extended). As a result, cost involved in the component replacement can be reduced. Concerning the undeteriorated components, when a quantity of use is reduced, the durable life of the entire digital multifunction peripheral is also extended.

Quantification of an environmental load in the digital multifunction peripheral 1 is explained below.

The digital multifunction peripheral 1 converts an environmental load caused by executed print processing into an environmental load value (e.g., emission [g] of carbon dioxide). The digital multifunction peripheral 1 converts factors of an environmental load in print processing executed once (one job) into environmental load values and adds up the environmental load values of the factors to thereby calculate an environmental load value (hereinafter also referred to as execution value) for the entire executed one job.

For example, the execution value for the executed one job can be calculated according to the following Formula 1:

Execution value=consumables (sheets, toners, stales, etc.)+deteriorated components (drums, developers, rollers, etc.)+electric power (Formula 1)

Factors related to the consumables include sheets, toners, staples, and the like. Consumption amounts of these factors are converted into environmental load values.

For example, the factor “sheets” is an environmental load value concerning sheets on which images are formed. For example, as the consumed amount of sheets, a size of sheets on which images are formed, the number of times of reuse, the number of printed sheets, a type of the sheets, and the like are assumed. It is assumed that environmental load values for the size of the sheets and the type of the sheets are set in advance. Therefore, when images are formed on new sheets, a value obtained by multiplying an environmental load value specified by a size and a type of the used sheets with the number of printed sheets is an environmental load value concerning the sheets. When sheets are reused (when reverse side paper is used), since sheets are not consumed anew, an environmental load value may be set to 0.

The factor “toners” is an environmental load value concerning toners used for image formation. For example, a consumption amount of the toners is calculated according to a printing ratio, used colors, the number of printed sheets, density, and the like. It is assumed that an environmental load value concerning a consumption amount of the toners is set in advance. Therefore, an environmental load value concerning the toners is calculated by calculating a consumption amount of the toners.

The factor “staples” is an environmental load value concerning stapling for sheets. It is assumed that an environmental load value for one stapling is set in advance. Therefore, an environmental load value corresponding to the number of times of stapling is calculated.

The factor concerning the deteriorated components includes components assumed to be deteriorated such as photoconductive drums, developers, and various rollers. These deteriorated components are assumed to be, for example, replaced according to deterioration. Specifically, an environmental load is large if deterioration involved in use is severe. Therefore, concerning the deteriorated components, a quantity of use is converted into an environmental load value.

The deteriorated components are driven according to not only print processing but also various kinds of processing in the digital multifunction peripheral 1. For example, in form-up, pre-run, inter-paper operation, and print end operation, the deteriorated components may be driven. Therefore, an environmental load value concerning the deteriorated components is calculated according to the number of times of warm-up, the number of times of pre-run, the number of times of printing, the number of times of inter-paper operation, the number of times of end operation, the number of times of switching of color and monochrome, the number of times of color printing, the number of times of duplex printing, the number of times of paper feeding, the number of times of fixing, drum operation time, developing device driving time, paper length in the conveying direction, and the like.

Concerning the electric power, electric power consumed by the units to operate in print processing only has to be converted into an environmental load value. Specifically, if an environmental load value per predetermined unit power is set, an amount of power used for print processing can be converted into an environmental load value. A consumption amount of electric power is calculated as a total of electric powers consumed for standby operation, sleep operation, warm-up operation, pre-run operation, printing operation, inter-paper operation, and end operation.

In Formula 1, values obtained by roughly dividing an execution value of an environmental load by factors of the environmental load are added up. On the other hand, the execution value of an environmental load may be calculated according to the following Formula 2.

Execution value=value for print execution (value for printing of one sheet×number of printed sheets×number of copies)+value for print preparation (operation before print execution+operation between print sheets+operation after print execution) Formula 2

Formula 2 is a formula for calculating an environmental load value for each operation related to print processing. The value for print execution means an environmental load value caused by operation for actually printing an image on a sheet. The value for print preparation is a value obtained by adding up an environmental load value due to the operation before print execution, an environmental load value due to the operation between print sheets, and an environmental load value due to the operation after print execution.

The operation before print execution is operation executed to print an image on a sheet. The operation before print execution is executed to set the inside of a printer in a state (temperature, etc.) suitable for executing printing. For example, the operation before print execution includes warm-up and pre-run. The operation before print execution is operation necessary for executing printing. Therefore, in Formula 2, an environmental load value caused by the operation before print execution is also included in an environmental load value in print processing performed once.

The operation between print sheets is operation executed between printing on one sheet and printing on another sheet when images are printed on plural sheets. For example, in print processing for plural sheets, as an interval of printing on sheets is shorter, an environmental load is reduced. Therefore, in Formula 2, an environmental load value caused by the operation in the printer carried out during printing on the sheets is also included in an environmental load value in the print processing for the plural sheets.

The operation after print execution is operation executed after the image is printed on the sheet. The operation after print execution is operation for shifting a state in the printer immediately after print execution to an appropriate standby state (e.g., temperature control or cleaning of residual toners). For example, the operation after print execution includes cleaning of residual toners and the like and temperature control in the printer. Therefore, in Formula 2, an environmental load value caused by the operation after print execution is also included in an environmental load value in print processing performed once.

As the value for print execution in Formula 2, a consumption amount of the consumables, a quantity of use (operation) of the deteriorated components, power consumption, and the like are converted into environmental load values on the basis of factors such as an image aggregating ratio (simplex or duplex and N-in-1), color or monochrome, a sheet size, a sheet type, and a sheet direction and the environmental load values are added up.

An index indicating a degree of reduction in an environmental load in executed print processing is explained below.

It is assumed that a numerical value called a degree of effort is calculated as the index indicating a degree of reduction in an environmental load. It is assumed that the degree of effort is calculated by the following Formula 3:

Degree of effort=(maximum value−execution value)/maximum value Formula 3

The maximum value is a reference value for determining to which degree actually executed print processing can reduce an environmental load. The maximum value is a maximum value of environmental load values assumed when a print target image is subjected to print processing. For example, the maximum value may be a value calculated by Formula 1 or 2 with environmental load values of factors in printing a print target image set as maximum values that can be assumed. The maximum value may be a value calculated as an environmental load value in printing a printing target image on each sheet at equal magnification. The maximum value can be considered as a reference value for calculating a degree of effort. In this case, the maximum value as the reference value may be an environmental load value obtained when a print target image is printed with standard settings (e.g., an environmental load value obtained when copy processing is performed with automatic settings are kept for all settings).

In Formula 3, the degree of effort is a numerical value indicating a degree of the execution value with respect to the maximum value. Specifically, the degree of effort is a value indicating to which degree the execution value contributes to a reduction in an environmental load with reference to the maximum value. For example, when the execution value and the maximum value are the same, the degree of effort is 0 [%]. This indicates that the execution value does not contribute to the reduction in an environmental load at all. As the execution value is smaller compared with the maximum value, the degree of effort is larger. As a result, the level of the degree of effort is an index indicating a degree of contribution to the reduction in an environmental load.

An example of the maximum value is explained below.

The maximum value may be calculated every time the degree of effort is calculated or may be stored in a lookup table in advance. It is assumed that the maximum value is stored in the lookup table in advance. In this case, a maximum value of an environmental load is stored in the lookup table for each of conditions (an image size, the number of images, etc.) of a print target image.

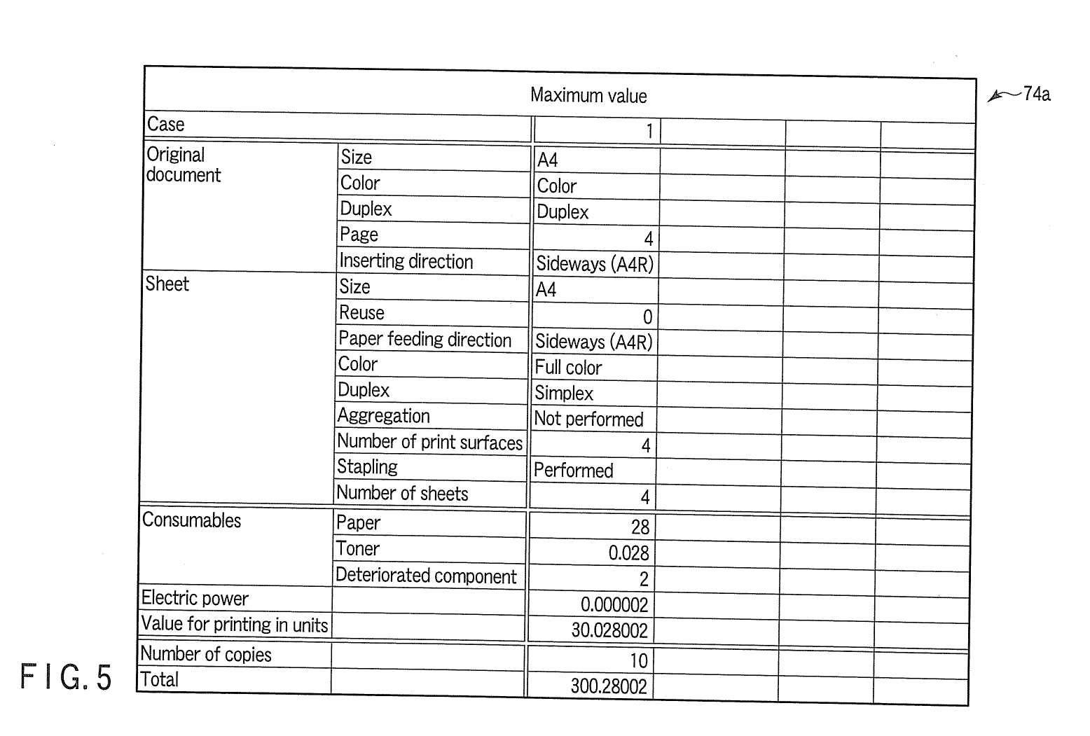

FIG. 5 is a diagram of an example of a lookup table (LUT) 74a for a maximum value in copy processing (a copy job).

The lookup table 74a shown in FIG. 5 is stored in the HDD 74 of the system control unit 61 in the digital multifunction peripheral 1. The lookup table 74a may be stored in the ROM 72. The calculation of the degree of effort may be performed by the management server 2 or the user terminal 3. When the management server 2 performs the calculation of the degree of effort, the lookup table is stored in the HDD 84 or the ROM 83 of the management server 2.

In the example shown in FIG. 5, settings concerning an original document are the A4 size, color, duplex, four pages, and sideways. Settings concerning a sheet in the example shown in FIG. 5 are the A4 size, no reuse of sheets, sideways, full color, simplex, that aggregation is not performed, the number of print surface is four, stapling is performed, and the number of printed sheets is four. These sheet settings are set such that an environmental load in print processing is maximized. The example shown in FIG. 5 indicates environmental load values due to consumption of the consumables, deterioration in the deteriorated components, and power consumption corresponding to the sheet settings. A value obtained by adding up these numerical values is an environmental load value in print processing in a unit of one copy. Further, when printing for plural copies is performed, a value obtained by multiplying the environmental load value in a unit of one copy with the number of prints is a maximum value of an environmental load in the entire print processing.

In the example shown in FIG. 5, as explained below, a value converted into emission of carbon dioxide is shown as a numerical value indicating an environmental load. For example, concerning the consumables, a value obtained by converting a consumption amount into emission of carbon dioxide with reference to unit consumption is shown. Concerning the deteriorated components, a value obtained by converting a value of the number of times of operation or operation time of the deteriorated components directly related to printing per one surface of a sheet into emission of carbon dioxide with reference to average life of the components is shown. Concerning the electric power, a value obtained by converting a value of the number of times of operation or operation time of units directly related to printing into emission of carbon dioxide is shown.

In the example shown in FIG. 5, the number of pages of an original document indicates a counting result of document reading. The number of print surfaces and the number of sheets in the sheet settings are associated with the number of pages of the original document.

In the example shown in FIG. 5, a maximum value of an environmental load related to a value for print execution is shown. A maximum value of an environmental load related to a value for print preparation (the operation before print execution, the operation between print sheets, and the operation after print end) is stored in a separately-set lookup table.

An example of history data including a degree of effort is explained below.

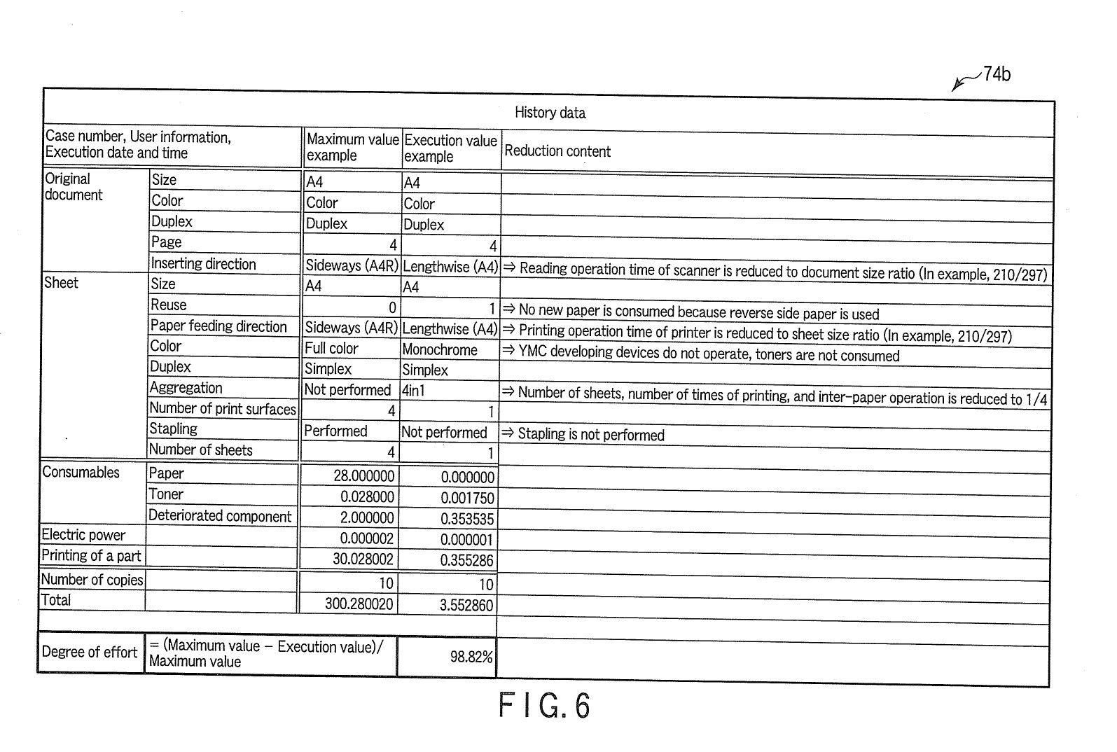

FIG. 6 is a diagram of an example of history data 74b including a degree of effort in copy processing (a copy job). The history data 74b shown in FIG. 6 is history data including a degree of effort calculated by using a maximum value shown in FIG. 5.

The history data 74b shown in FIG. 6 is stored in the HDD 74 of the system control unit 61 in the digital multifunction peripheral 1. The history data 74b may be stored in the HDD 84 of the management server 2.

The degree of effort is a numerical value for recognizing an environmental load due to executed print processing. For example, the degree of effort is calculated from a maximum value and an execution value by using Formula 3. Specifically, as the degree of effort, an amount of an environmental load that can be reduced with respect to factors, for which the maximum value is calculated, is represented as a numerical value.

The calculation of the degree of effort may be performed by the management server 2 or the user terminal 3. When the management server 2 calculates the degree of effort, the lookup table is stored in the HDD 84 or the ROM 83 of the management server 2.

In the history data shown in FIG. 6, an environmental load is reduced in the following points in executed print processing (copy processing).

In the executed copy processing, a short side of an original document is set as a sub-scanning direction. Compared with a maximum value obtained when a long side of the original document is set as the sub-scanning direction, in the executed copy processing, scanner operation time is reduced to the length of the short side/the length of the long side (210/297 in the case of the A4 size). Therefore, in the execution value, an environmental load is reduced by a reduction in the operation time of the scanner compared with the maximum value.

In the executed copy processing, new sheets are not consumed because reverse side paper is used (sheets are reused). Compared with a maximum value obtained when images are printed on new sheets, in the executed copy processing, since consumption of the sheets (the new sheets) is reduced, an environmental load for the sheets is reduced.

In the executed copy processing, the short side of the sheet is set as a paper feeding (conveying) direction. Compared with a maximum value obtained when the long side of the sheet is set as the paper feeding direction, in the executed copy processing, print operation time (time required for actual image formation on the sheet such as sheet conveying time, image formation time, and image development time) is reduced to the length of the short side/the length of the long side (210/297 in the case of the A4 size). Therefore, in the execution value, an environmental load is reduced by a reduction in the print operation time compared with the maximum value.

In the executed copy processing, images are printed in monochrome rather than in color. In the monochrome printing, developing devices for yellow (Y), magenta (M), and cyan (C) do not operate and toners of the colors (Y, M, and C) are not consumed. Therefore, in the execution value, an environmental load is reduced by a reduction in the operation of the developing devises for the colors and the consumption of the toners of the colors.

In the executed copy processing, each of images for four pages is reduced to a quarter size and the images are collectively printed on one sheet (a sheet of a size same as a size of an original document) (4-in-1 printing). Compared with a maximum value obtained by printing four images on four sheets, in the executed copy processing (4-in-1 printing), the number of sheet and the number of times of printing are reduced to a quarter and the operation between print sheets is also reduced. Therefore, in the execution value, an environmental load is reduced by the reduction in the number of sheet, the number of times of printing, and the operation between print sheets due to the consolidation of images of plural pages into an image printed on one sheet.

In the executed copy processing, staples are not consumed. Compared with a maximum value obtained when staples are consumed, in the executed copy processing, an environmental load is reduced by a reduction in the consumption of the staples.

As explained above, in the example shown in FIG. 6, since the environmental load is reduced in the respective factors, a numerical value 98.82% is obtained as the degree of effort. This degree of effort is obtained by the contrivance of print setting (copy setting) by the user and indicates a result obtained by reducing an environmental load by the user (a degree of contribution to a reduction in an environmental load). The degree of effort is displayed on the operation panel 16 of the digital multifunction peripheral 1. Further, the degree of effort may be managed by the management server 2 or may be displayed on the display unit 96 of the user terminal 16.

Announcement processing for a degree of effort involved in processing (print processing, copy processing, etc.) executed once by the digital multifunction peripheral 1 is explained below.

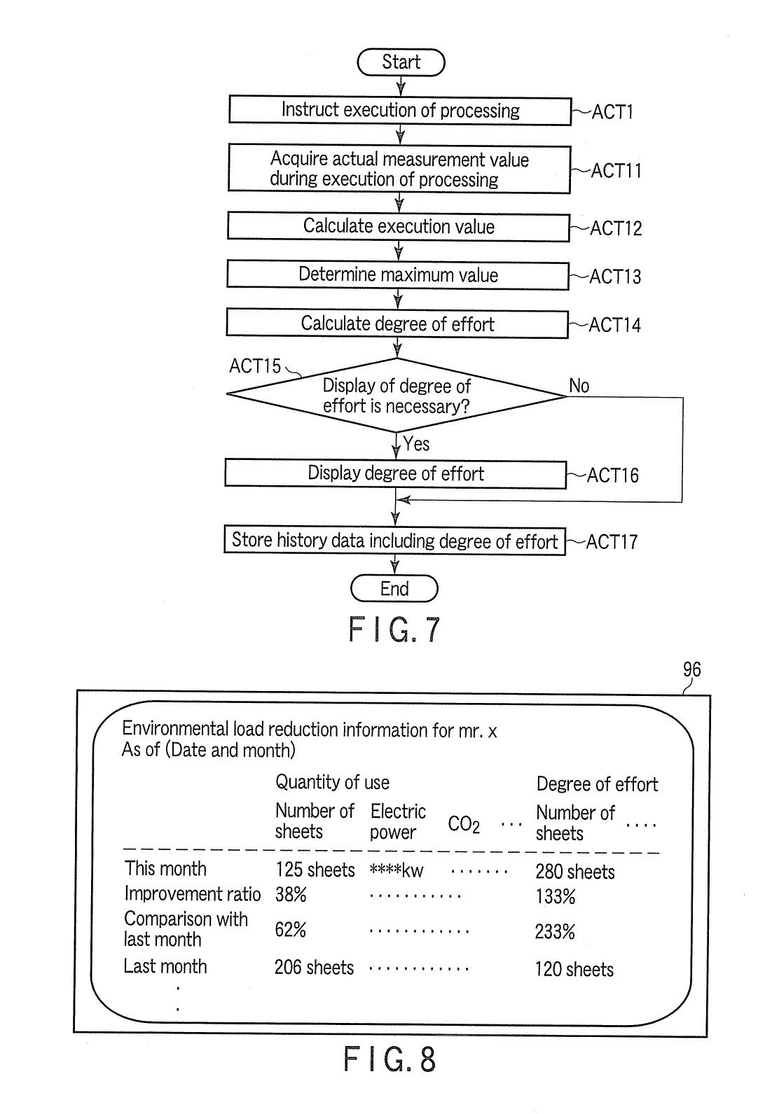

FIG. 7 is a flowchart for explaining the announcement processing for a degree of effort involved in the processing performed once.

For example, when an instruction for the start of copying is input to the operation panel 16 or when a request for execution of printing is received through the network, the system control unit 61 outputs execution instructions for various kinds of processing to the control units for the respective units such as the scanner control unit 62, the printer control unit 63, and the finisher control unit 64 (ACT 1). For example, when copy processing is executed, the system control unit 61 analyzes content of setting by the user and determines document setting and sheet setting according to the user setting. On the basis of the determination, the system control unit 61 instructs the scanner control unit 62 to execute reading of an original document corresponding to the document setting and instructs the printer control unit 63 to execute printing of a read image of the original document corresponding to the sheet setting.

The scanner control unit 62, the printer control unit 63, and the finisher control unit 64 execute various kinds of processing according to the execution instructions from the system control unit 61. The scanner control unit 62, the printer control unit 63, and the finisher control unit 64 output execution results and the like of the respective kinds of processing to the system control unit 61 as appropriate. For example, the scanner control unit 62, the printer control unit 63, and the finisher control unit 64 respectively measure information for calculating an execution value of an environmental load in the executed processing.

The information for calculating an execution value of an environmental load is an actual measurement value indicating operation states of the units in the executed processing (the print processing, the copy processing, etc.). For example, as the information for calculating an execution value of an environmental load, a consumption amount of the consumables, operation times of the units (or processing steps), power consumption, and the like are measured. The information for calculating an execution value of an environmental load includes not only an actual measurement value (the operation times of the units, etc.) in a value for print execution but also actual measurement values (the operation times of the units, etc.) in a value for print preparation (the operation before print execution, the operation between print sheets, and the operation after print execution).

Specifically, when the processing requested by the user ends, the system control unit 61 acquires, from the printer control unit 63, the finisher control unit 64, and the scanner control unit 62, actual measurement values indicating operation states of the units as the information for calculating an execution value of an environmental load in the executed processing (ACT 11).

After acquiring the actual measurement values indicating the operation states of the units, the system control unit 61 calculates an execution value of an environmental load in the executed processing on the basis of information indicating the consumption amount of the consumables, the operation times of the processing steps, the power consumption, and the like (ACT 12). For example, the system control unit 61 converts, for each of factors, the information indicating the consumption amount of the consumables, the operation times of the processing steps, the power consumption, and the like into environmental load values and calculates an execution value of an environmental load in the executed processing using Formula 1 or Formula 2.

After calculating the execution value of an environmental load in the execute processing, the system control unit 61 determines a maximum value corresponding to a print target image according to the lookup table 74a (ACT 13). As explained above, the maximum value is a reference value for calculating a degree of effort (a degree of contribution) of an environmental load in the executed print processing or copy processing. The system control unit 61 may determine, for each of the factors in the processing, a maximum value of an environmental load that can be assumed and calculate a maximum value for the processing by applying maximum values of the factors to Formula 1 or Formula 2.

After determining the maximum value as the reference value for the processing, the system control unit 61 calculates a degree of effort for an environmental load in the actually executed processing (ACT 14). The degree of effort is calculated from the execution value and the maximum value by using Formula 3. The degree of effort is a numerical value indicating a ratio of the execution value to the maximum value.

After calculating the degree of effort, the system control unit 61 determines whether it is necessary to announce the calculated degree of effort to the user (ACT 15). The system control unit 61 determines, on the basis of setting, whether it is necessary to announce the degree of effort. The necessity of announcement may be unconditionally set or conditions for necessitating the announcement (conditions for unnecessitating the announcement) may be set. As the latter, it is also possible to set to announce the degree of effort only when the degree of effort is equal to or larger than a set value (or smaller than the set value).

If the system control unit 61 determines that the announcement is necessary (YES in ACT 15), the system control unit 61 displays the calculated degree of effort on the display unit 16a of the operation panel 16 (ACT 16). When the executed processing is network print processing corresponding to a print request from the user terminal 3, the system control unit 61 may transfer the calculated degree of effort to the user terminal 3 as a request source of the printing and cause the user terminal 3 to display the degree of effort on the display unit 96 of the user terminal 3.

The system control unit 61 stores the calculated degree of effort in the HDD 74 as the history data 74b (ACT 17). The history data 74b may be stored in the management server 2. When the history data 74b is stored in the management server 2, the system control unit 61 transfers information including the calculated degree of effort to the management server 2. The system control unit 61 transfers the execution value and the maximum value to the management server 2 together with the degree of effort. When a user can be specified by authentication or the like, the system control unit 61 transfers information indicating users to the management server 2 together with the degree of effort. The management server 2 that receives such information including the degree of effort stores the information including the degree of effort in a storage device such as the HDD 84.

The user terminal 3 may be able to check the history data 74b stored in the HDD 74 in the digital multifunction peripheral 1 or the HDD 84 of the management server 2. For example, when the management server 2 stores the history data 74b including the information indicating users, the user terminal 3 may display, for example, a degree of effort of an environmental load including a state of use in the past for a specific user on the display unit 96.

For example, FIG. 8 is a diagram of a display example of a reduction (a degree of effort) in an environmental load displayed on the display unit 96 of the user terminal 3 for the specific user. In the display example shown in FIG. 8, as reduction information of an environmental load for a user Mr. X, besides a degree of effort, quantities of use (the number of sheets, electric power, a value converted into carbon dioxide), and the like, for example, information concerning comparison with a state of use in the past (e.g., comparison of this month and the last month) is displayed. These kinds of information can be calculated by accumulating history data of the users.

A part or all of the kinds of processing in ACT 11 to ACT 17 explained above may be executed by the management server 2 or an external apparatus that can communicate with the digital multifunction peripheral 1 through the network 5. For example, the external apparatus such as the management server 2 that can communicate with the digital multifunction peripheral 1 may acquire an actual measurement value for calculating an execution value of an environmental load from the digital multifunction peripheral 1, calculate an execution value, a maximum value, and a degree of effort, and return a result of the calculation to the digital multifunction peripheral 1. The processing other than ACT 16 may be collectively executed by the management server 2.

The printer according to this embodiment is explained above with the printer of the electrophotographic system as an example. However, the present invention is not limited to this. The present invention may be applied to printers employing a thermal system and an ink jet system. The environmental load announcing apparatus is explained above with the image forming apparatus as an example. However, the present invention is not limited to this. The environmental load announcing apparatus may be realized by the user terminal 3.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An environmental load announcing apparatus configured to announce an environmental load in an image forming apparatus, the environmental load announcing apparatus comprising:
an execution-value calculating unit configured to calculate, as an execution value, a value of an environmental load required by the image forming apparatus to print a print target image on a sheet;
a degree calculating unit configured to set, as a reference value, a value of an environmental load caused if the image forming apparatus prints, with reference setting content, the print target image on the sheet and calculate a degree of the execution value calculated by the execution-value calculating unit with respect to the reference value; and
a control unit configured to cause a display device to display information based on the degree of the execution value with respect to the reference value calculated by the degree calculating unit.

2. The environmental load announcing apparatus according to claim 1, wherein the execution-value calculating unit calculates, as the execution value, a value of an environmental load corresponding to operation time in which the image forming apparatus operates to print the print target image on the sheet.

3. The environmental load announcing apparatus according to claim 1, wherein the execution-value calculating unit calculates, on the basis of operation time required for various processing steps for printing the print target image on the sheet, values of environmental loads caused in the processing steps and calculates an execution value obtained by adding up the values of the environmental loads caused in the processing steps.

4. The environmental load announcing apparatus according to claim 1, wherein the execution-value calculating unit calculates an execution value including a value of an environmental load caused by preparation operation for printing the print target image on the sheet.

5. The environmental load announcing apparatus according to claim 4, wherein the preparation operation for printing includes operation before print execution for changing a state in the image forming apparatus to a state for executing the printing.

6. The environmental load announcing apparatus according to claim 4, wherein the preparation operation for printing includes operation executed by the image forming apparatus during printing on continuous sheets in print processing for performing printing on plural sheets.

7. The environmental load announcing apparatus according to claim 4, wherein the preparation operation for printing includes operation executed by the image forming apparatus for post-processing after the print target image is printed on the sheet.

8. The environmental load announcing apparatus according to claim 1, wherein the execution-value calculating unit calculates an execution value including a value of environmental load based on operation time of a deteriorated component that the image forming apparatus causes to operate to print the print target image on the sheet.

9. The environmental load announcing apparatus according to claim 1, wherein the reference value is a maximum value of environmental load values with factors converted into the environmental load values assumed as maximums in print processing for printing the print target image on the sheet.

10. The environmental load announcing apparatus according to claim 9, wherein the information based on the degree is information represented by (the maximum value—the execution value)/the maximum value.

11. A multifunction peripheral comprising:
a scanner configured to read an image of an original document;
a printer configured to print the image on a sheet;
an execution-value calculating unit configured to calculate, as an execution value, a value of an environmental load required by the printer to print the image of the original document read by the scanner on the sheet;
a degree calculating unit configured to set, as a reference value, a value of an environmental load caused if the printer prints, with reference setting content, the image of the original document read by the scanner on the sheet and calculate a degree of the execution value calculated by the execution-value calculating unit with respect to the reference value; and
a display device configured to display information based on the degree of the execution value with respect to the reference value calculated by the degree calculating unit.

12. The multifunction peripheral according to claim 11, wherein the execution-value calculating unit calculates, as the execution value, a value of an environmental load corresponding to operation time in which the printer operates to print the print target image on the sheet.

13. The multifunction peripheral according to claim 11, wherein the execution-value calculating unit calculates, on the basis of operation time required for various processing steps for printing the print target image on the sheet, values of environmental loads caused in the processing steps and calculates an execution value obtained by adding up the values of the environmental loads caused in the processing steps.

14. The multifunction peripheral according to claim 11, wherein the execution-value calculating unit calculates an execution value including a value of an environmental load caused by preparation operation for printing the print target image on the sheet.

15. The multifunction peripheral according to claim 11, wherein the reference value is a maximum value of environmental load values with factors converted into the environmental load values assumed as maximums in print processing for printing the print target image on the sheet.

16. The multifunction peripheral according to claim 15, wherein the information based on the degree is information represented by (the maximum value—the execution value)/the maximum value.

17. An environmental-load announcing method comprising:
an environmental-load announcing apparatus calculating, as an execution value, a value of an environmental load required by an image forming apparatus to print a print target image on a sheet;
the environmental-load announcing apparatus setting, as a reference value, a value of an environmental load caused if the image forming apparatus prints, with reference setting content, the print target image on the sheet and calculating a degree of the calculated execution value with respect to the reference value; and
the environmental-load announcing apparatus causing a display device to display information based on the calculated degree of the execution value with respect to the reference value.

18. The method according to claim 17, wherein the reference value is a maximum value of environmental load values with factors converted into the environmental load values assumed as maximums in print processing for printing the print target image on the sheet.

19. The method according to claim 17, wherein the information based on the degree is information represented by (the maximum value—the execution value)/the maximum value.
